(19) United States
(12) Patent Application Publication
(10) Pub. No.: US 2014/0232954 A1
(43) Pub. Date: Aug. 21, 2014

(54) DRIVER IC AND IMAGE DISPLAY DEVICE

(71) Applicant: Renesas SP Drivers Inc., Tokyo (JP)

(72) Inventor: Shinya Suzuki, Kodaira (JP)

(73) Assignee: Renesas SP Drivers Inc., Tokyo (JP)

(21) Appl. No.: 14/171,831

(22) Filed: Feb. 4, 2014

(30) Foreign Application Priority Data
Feb. 15, 2013 (JP) 2013-027585

(51) Int. Cl. G02F 1/1333; G02F 1/133

(52) U.S. Cl. CPC G02F 1/13338; G02F 1/13306
USPC 349/12; 349/152; 349/150

(57) ABSTRACT

The driver IC used to activate a display panel has a free region which is proactively provided therein so as to separate its external connection terminals from an edge side thereof by a distance representing at least one row of the terminals. In mounting the driver IC on a display panel by COG technique, the driver IC may be COG-mounted so that bent parts of lead-out lines led out from the display panel and bent at a midway along their lengths to have a narrowed pitch are in position to overlie the free region. The same effect as achieved by reducing the size of the short side of the driver IC by the size of the free region can be obtained. According to the invention, the reduction in frame size of an image-display panel can be readily realized without the need for reducing the chip size of a driver IC.

### CROSS-REFERENCE TO RELATED APPLICATIONS

The Present application claims priority from Japanese application JP 2013-027585 filed on Feb. 15, 2013, the content of which is hereby incorporated by reference into this application.

### BACKGROUND

The present invention relates to a driver IC (Integrated Circuit) for activating an image-display panel, further an image display device having an image-display panel with a driver IC mounted thereon by COG (Chip on Glass) method, and a technique useful in application to e.g. a liquid crystal display device.

There has been known a form for mounting an image display device including a liquid crystal display panel, and a driver IC which is mounted on the glass substrate of the liquid crystal display panel by COG method. In such a form, source and other lines of a liquid crystal display panel are led out to a face of a glass substrate, and connected with drive terminals of a driver IC. The number of source and other lines of a liquid crystal display panel constantly increases as the resolution of the liquid crystal display panel rises. On the other hand, driver ICs have their own limits in size and as such, the trend to the reduction in the pitch between terminals including one for driving a source line is being accelerated. On such account, source and other lines led out from a display region of a liquid crystal display panel to a driver IC-mount region are bent at a midway along their lengths, whereby the pitch therebetween is made narrower to fit drive terminals.

The mounting form as described above is disclosed in e.g. JP-A-2009-244781.

### SUMMARY

It is required to ensure no small wiring region between the liquid crystal display panel and the driver IC for the purpose of reducing the pitch by bending, in groups, signal lines led out from the display region of a liquid crystal display panel at a midway along their lengths so that the lines extend at slants toward the center of the group as if coming together. Further, it becomes proper for a liquid crystal display panel to have a smaller frame width with the spread of portable information terminal devices including a tablet and a smart phone. Hence, there has been a tendency to reduce the short side length of a driver IC chip, and it is now difficult to realize a frame having a further smaller width by means of reducing the chip size. Reducing the frame width of a display panel means to reduce, in size, the short side of a driver IC-mount region neighboring the display region of the display panel. For the purpose of reducing the chip size by means of reducing the frame width, it is sufficient to reduce the layout area by further scale-down of the process, decrease in the number of functions and the like. However, it has been difficult to readily reduce the size of the short side of a driver IC chip. This is because the cost is raised with the progress of the scale-down, and a higher-level function and a higher performance are often required.

It is an object of the invention to allow the easy materialization of an image-display panel having a smaller frame width without the need for reducing the chip size of a driver IC.

The above and other problems and novel features thereof will become apparent from the description hereof and the accompanying drawings.

Of the embodiments herein disclosed, the representative embodiment will be briefly outlined below.

The driver IC used to activate a display panel has a free region proactively provided therein so as to separate its external connection terminals from an edge side thereof by a distance representing at least one row thereof. In mounting the driver IC on e.g. a display panel, the driver IC may be mounted so that bent parts of lead-out lines led out from a display region of the display panel, and bent at a midway along their lengths to have a narrowed pitch are put in position to overlie the free region. The same effect as achieved by reducing the size of the short side of the driver IC by the size of the free region can be obtained.

Of the embodiment herein disclosed, the representative embodiment brings about the effect as briefly described below.

That is the reduction in frame width of an image-display panel can be realized readily without reducing the size of a driver IC chip.

### BRIEF DESCRIPTION OF THE DRAWINGS

FIG. 1 is a plane view showing, by example, the first embodiment of the external connection terminal array of a driver IC mounted on a display panel;

FIG. 2 is a plane view showing, as a comparative example, an external connection terminal array of a driver IC without a free region provided proactively;

FIG. 3 is an explanatory view showing, by example, chip and electrode sizes of the driver IC without a free region shown in FIG. 2;

FIG. 4 is an explanatory view showing, by example, an image display device having a liquid crystal display panel equipped with the driver IC shown in FIG. 1;

FIG. 5 is an explanatory view showing, by example, the form of mounting the driver IC as shown in FIG. 1 on a TFT array substrate;

FIG. 6 is an explanatory view showing, by example, the form of mounting a driver IC without a free region on a mount region;

FIG. 7 is an explanatory view showing a difference between the embodiments shown in FIGS. 5 and 6 in the form of mounting the driver IC;

FIG. 8 is a block diagram showing, by example, the structure of the driver IC shown in FIG. 1;

FIG. 9 is a block diagram showing another structure of the driver IC shown in FIG. 1;

FIG. 10 is a plane view showing, by example, the second embodiment of the external connection terminal array of the driver IC mounted on a display panel;

FIG. 11 is an explanatory view showing, by example, the form of mounting the driver IC shown in FIG. 10 on the TFT array substrate;

FIG. 12 is a plane view showing, by example, the third embodiment of the external connection terminal array of the driver IC mounted on a display panel; and

FIG. 13 is an explanatory view showing, by example, the form of mounting the driver IC shown in FIG. 12 on the TFT array substrate.

### DETAILED DESCRIPTION

### 1. Summary of the Embodiments

The embodiments herein disclosed will be outlined first. Here, the reference numerals or characters for reference to the drawings, which are accompanied with paired round brackets, only exemplify what the concepts of members or components referred to by the numerals or characters contain.

[1]<Separate Pads Used for Activation of the Display Panel From an Edge Side of the Chip by a Distance Representing at Least One Row Thereof>

The driver IC (1a, 1b, 1c) used to activate a display panel has, in plane view, an appearance of a rectangular form having a pair of a first edge side (2) and a second edge side (3) in parallel with each other, and has rows of external connection terminals (4, 5) formed close to the first and second edge sides respectively. The driver IC has a free region (6, 7) formed between at least one of the first and second edge sides and the row of external connection terminals opposed thereto, and arranged so that at least one row of external connection terminals can be disposed therein.

According to the embodiment like this, it is sufficient to mount a driver IC on a display panel so that bent parts of lead-out lines led out from a display region of the display panel and bent at a midway along their lengths to have a narrowed pitch are put in position to overlie the free region. The same effect as achieved by reducing the size of the short side of the driver IC by the size of the free region can be obtained. Therefore, the reduction in frame size of an image-display panel can be realized readily without the need for reducing the chip size of a driver IC. Providing the free region in the driver IC for activating a display panel is different from simply gathering a group of external terminals of a chip towards the center of the group in idea of the invention, which makes means for accomplishing the goal of attaining the same effect as achieved by reducing the size of a short side of a driver IC of a display panel by the size of a free region, which is hard to reach by a simple mounting on a substrate.

[2]<Forming the Free Region on the Display Drive Buffer Side of the Display Controller>

The driver IC (1a, 1c) as described in [1] further has: a display controller (108) used to activate a display panel as an internal circuit connected to the row of external connection terminals. The display controller has display drive buffers (120, 121) connected to the external connection terminals close to the first edge side. The free region is formed between the first edge side and the external connection terminals opposed thereto.

According to the embodiment like this, even in the case of the driver IC having a display controller, the reduction in frame size of a display panel can be realized readily.

[3]<Forming the Free Region on the Host Interface Buffer Side of the Display Controller>

In the driver IC as described in [2], the display controller has a host interface buffer (built in the system interface circuit (SYSIF) 125) connected to the external connection terminals close to the second edge side. The free region is also formed between the second edge side and the external connection terminals opposed thereto.

According to the embodiment like this, the same effect as achieved by reducing the size of the short side of a driver IC can be attained on the host interface side as on the drive side, thanks to the free region provided on the host interface side of the driver IC. It is possible to contribute to the materialization of further frame size reduction of a display panel.

[4]<Forming the Free Region on the Touch Drive and Detection Buffer Side of the Touch Panel Controller>

The driver IC as described in [2] further has a touch panel controller (106) used for activation of a touch panel and touch detection as an internal circuit connected to the row of external connection terminals. The touch controller has a touch drive buffer (110) and a touch detection input buffer (111) connected to the external connection terminals close to the first edge side.

According to the embodiment like this, the reduction in frame size of a display panel can be realized readily even in case that the driver IC has a touch panel controller and consequently the number of external connection terminals for touch drive and touch detection is increased, and the reduction in the pitch of the external connection terminals on the drive side is caused to further progress.

[5]<Forming the Free Region on the Host Interface Side of the Display Controller and the Data Processor>

In the driver IC as described in [4], the internal circuit further has a data processor (107) connected with the touch panel controller. The display controller has a host interface buffer, and the data processor has a host interface buffer (built in the subprocessor 107); both the host interface buffers are connected to the external connection terminals close to the second edge side. The free region is also formed between the second edge side and the external connection terminals opposed thereto.

According to the embodiment like this, the same effect as achieved by reducing the size of a short side of a driver IC can be attained on the host interface side as on the drive side thanks to the free region provided on the host interface side of the driver IC even in case that the driver IC is further sophisticated in function by arranging a touch panel controller and a data processor on the chip. Therefore, it is possible to contribute to the materialization of further frame size reduction of a display panel.

[6]<Forming the Free Region on the Host Interface Buffer Side of the Display Controller>

The driver IC (1b) as described in [1] further has a display controller used to activate a display panel as an internal circuit connected to the row of external connection terminals. The display controller has a display drive buffer connected to the external connection terminals close to the first edge side. The display controller has a host interface buffer connected to the external connection terminals close to the second edge side. The free region is formed between the second edge side and the external connection terminals opposed thereto.

According to the embodiment like this, the same effect as achieved by reducing the size of the short side of a driver IC can be attained even with the free region provided only on the host interface side as on the drive side. Therefore, the reduction in frame size of a display panel can be realized readily.

[7]<Forming the Free Region on the Touch Drive and Detection Buffer Side of the Touch Panel Controller>

The driver IC as described in [6] further has, as an internal circuit connected to the row of external connection terminals, a touch panel controller used for activation of a touch panel and touch detection, and a data processor connected with the touch panel controller. The touch panel controller has a touch drive buffer and a touch detection input buffer, both connected to the external connection terminals close to the first edge side. The data processor has a host interface buffer connected to the external connection terminals close to the second edge side.

According to the embodiment like this, the same effect as achieved by reducing the size of a short side of a driver IC can be attained thanks to the free region provided on the host interface side of the driver IC even in case that the driver IC is further sophisticated in function by arranging a touch panel controller and a data processor on the chip. Therefore, it is possible to contribute to the materialization of frame size reduction of a display panel.

[8]<External Connection Terminals Arranged in Zigzag>

In the driver IC as described in [1], the external connection terminals close to the first edge side are arranged in zigzag and form a plurality of rows.

According to the embodiment like this, the same effect and advantage as those described in the paragraph subsequent to [1] can be obtained even in case that the drive-side external connection terminals of a driver IC having its limits in chip size cannot be arranged in line owing to the increase in the number of the external connection terminals, and there is no other choice but to dispose the external connection terminals in zigzag.

[9]<Bent Parts of the Drive-Side Mount Lines is Formed in Position to Overlie the Driver IC>

The image display device (20) includes: an image-display panel (21) having a TFT array substrate (22) with TFTs and pixel electrodes arranged like a matrix; and a driver IC (1a, 1c) mounted on the TFT array substrate of the image-display panel according to COG technique. Drive-side mount lines (30) and host-side mount lines (40) are each led to where the driver IC is COG-mounted on the TFT array substrate and bent at a midway along their lengths, whereby their line pitches are reduced. The driver IC has, in plane view, an appearance of a rectangular form, and has a row of first external connection terminals (4) close to a first edge side (2) corresponding to one of a pair of long sides of the rectangular form extending along a longitudinal direction thereof, and which are connected with the drive-side mount lines, and a row of second external connection terminals (5) close to a second edge side (3) corresponding to the other long side of the rectangular form, and connected with the host-side mount lines. Bent parts (31) where the drive-side mount lines are bent are formed in position so as to partially overlie a free region (6) between the first edge side and the row of first external connection terminals.

According to the embodiment like this, the driver IC is mounted so that bent parts of lead-out lines led out from the display panel and bent at a midway along their lengths to have a narrowed pitch are put in position to overlie the free region. The same effect as achieved by reducing the size of the short side of the driver IC by the size of the free region can be obtained. Therefore, the reduction in frame size of an image-display panel can be realized readily without the need for reducing the chip size of a driver IC.

[10]<Driver IC Having a Display Controller>

In the image display device as described in [9], the driver IC has a display controller operable to drive TFT electrodes through the first external connection terminals. The drive-side mount lines include wiring lines connecting to the electrodes.

According to the embodiment like this, even in the case of the driver IC having a display controller, the reduction in frame size of a display panel can be realized readily.

[11]<Driver IC Having a Touch Panel Controller>

In the image display device as described in [10], the image-display panel has a touch panel incorporated in an upper portion of the TFT array substrate. The driver IC further has a touch panel controller operable to control, through the first external connection terminals, activation of the touch panel and touch detection. The drive-side mount lines include wiring lines which connect to drive electrodes and detection electrodes of the touch panel.

According to the embodiment like this, the reduction in frame size of a display panel can be realized readily even in case that the driver IC has a touch panel controller and consequently the number of external connection terminals for touch drive and touch detection is further increased, and the reduction in the pitch of the external connection terminals on the drive side is caused to progress.

[12]<Forming Bent Parts of the Host-Side Mount Lines in Position to Overlie the Driver IC

In the image display device as described in [9], bent parts (41) where the host-side mount lines are bent are formed in position so as to partially overlie a free region (7) between the second edge side and the row of second external connection terminals (see the driver IC 1c).

According to the embodiment like this, the same effect as achieved by reducing the size of the short side of a driver IC can be attained on the host interface side as on the drive side, thanks to the free region provided on the host interface side of the driver IC. Therefore, it is possible to realize further frame size reduction of a display panel.

[13]<Driver IC Having a Display Controller>

In the image display device as described in [12], the driver IC has a display controller operable to drive TFT electrodes through the first external connection terminals, and connected to the host-side mount lines through the second external connection terminals. The drive-side mount lines include wiring lines connecting to the electrodes. The host-side mount lines include wiring lines connectable to FPC (flexible Printed Circuit) for interfacing the image-display panel to outside.

According to the embodiment like this, the same effect as achieved by reducing the size of the short side of a driver IC can be obtained on both the drive side and the host interface side on condition that the driver IC has a display controller.

[14]<Driver IC Having Touch Panel Controller>

In the image display device as described in [13], the image-display panel has a touch panel incorporated in an upper portion of the TFT array substrate. The driver IC further has a touch panel controller operable to control, through the first external connection terminal, activation of the touch panel and touch detection, and a data processor connected with the touch panel controller and connected through the second external connection terminals to the host-side mount lines. The drive-side mount lines include wiring lines connecting to drive electrodes and detection electrodes of the touch panel.

According to the embodiment like this, the same effect as achieved by reducing the size of a short side of a driver IC can be attained on the host interface side as on the drive side, thanks to the free region provided on the host interface side of the driver IC even in case that the driver IC is further sophisticated in function by arranging a touch panel controller and a data processor on the chip. Therefore, further frame size reduction of a display panel can be realized.

[15]<Bent Parts of the Host-Side Mount Lines Formed in Position to Overlie the Driver IC>

The image display device (20) includes: an image-display panel having a TFT array substrate with TFTs and pixel electrodes arranged like a matrix; and a driver IC (1b) mounted on the TFT array substrate of the image-display panel according to COG technique. Drive-side mount lines and host-side mount lines are each led to where the driver IC is COG-mounted on the TFT array substrate and bent at a midway along their lengths, whereby their line pitches are reduced. The driver IC has, in plane view, an appearance of a rectangular form, and has a row of first external connection terminals close to a first edge side corresponding to one of a pair of long sides of the rectangular form extending along a longitudinal direction thereof, and which are connected with the drive-side mount lines, and a row of second external connection terminals close to a second edge side corresponding to the other long side of the rectangular form, and connected with the host-side mount lines. Bent parts where the host-side mount lines are bent are formed in position so as to partially overlie a free region between the second edge side and the row of second external connection terminals.

According to the embodiment like this, the same effect as achieved by reducing the size of the short side of a driver IC can be attained only on the host interface side as on the drive side because of the free region on the host interface side of the driver IC. Therefore, the reduction in frame size of a display panel can be realized.

[16]<Driver IC Having a Display Controller>

In the image display device as described in [15], the driver IC has a display controller operable to drive TFT electrodes through the first external connection terminals, and connected to the host-side mount lines through the second external connection terminals. The drive-side mount lines include wiring lines connecting to the electrodes. The host-side mount lines include wiring lines connectable to FPC (flexible Printed Circuit) for interfacing the image-display panel to outside.

According to the embodiment like this, the reduction in frame size of a display panel is realized on the host interface side connectable to FPC line in the case of the driver IC having a display controller.

[17]<Driver IC Having a Touch Panel Controller>

In the image display device as described in [16], the image-display panel has a touch panel superposed on the TFT array substrate. The driver IC further has a touch panel controller operable to control, through the first external connection terminals, activation of the touch panel and touch detection, and a data processor connected with the touch panel controller and connected through the second external connection terminals to the host-side mount lines. The drive-side mount lines include wiring lines connecting to drive electrodes and detection electrodes of the touch panel.

According to the embodiment like this, the same effect as achieved by reducing the size of a short side of a driver IC can be attained on the host interface side, thanks to the free region provided on the host interface side of the driver IC even in case that the driver IC is further sophisticated in function by arranging a touch panel controller and a data processor on the chip. Therefore, frame size reduction of a display panel can be realized.

### 2. Further Detailed Description of the Embodiments

The embodiments will be described further in detail.

### First Embodiment

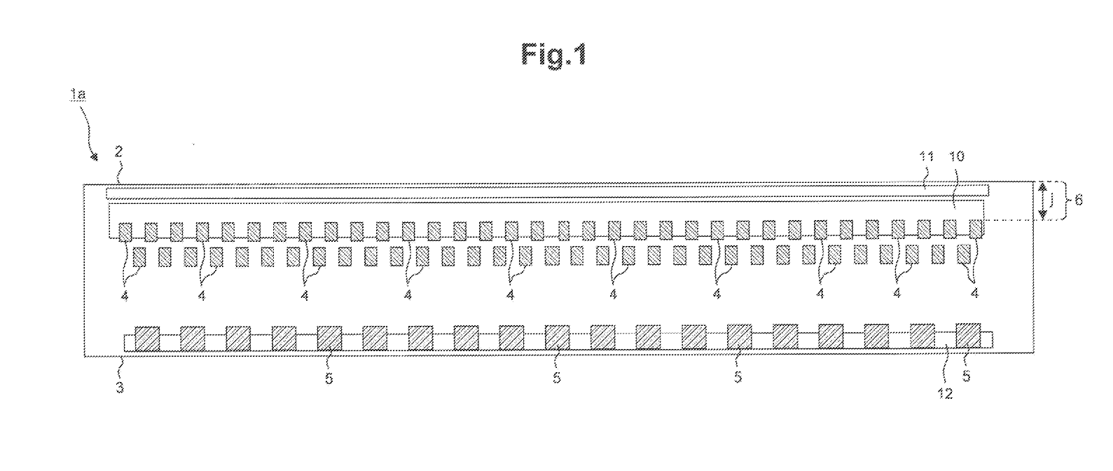

FIG. 1 shows, by example, the first embodiment of an external connection terminal array of a driver IC to be mounted on a display panel. The driver IC 1a is a semiconductor chip used to activate a circuit to be activated, such as a display panel, which is also referred to as “bare chip” or “flip chip”. Although no special restriction is intended, the driver IC 1a is arranged by forming a required circuit on a substrate such as a substrate of semiconductor typified by a monocrystalline silicon by the semiconductor integrated circuit manufacturing techniques including CMOS integrated circuit manufacturing technique.

The driver IC 1a has, in plane view, an appearance of a rectangular form having a pair of first and second edge sides 2 and 3 in parallel with each other. The driver IC 1a includes rows of external connection terminals 4 and 5 formed near the first and second edge sides; the rows of first external connection terminals 4 are near the first edge side 2, and the row of second external connection terminal 5 is near the second edge side. Although no special restriction is intended, the external connection terminals 4 are disposed in zigzag, forming two rows. Although no special restriction is intended, the external connection terminals 4 are arranged to be higher than the external connection terminals 5 in layout density. Although no special restriction is intended, the external connection terminals 4 and 5 each include: electrode pads formed by parts of lines included in a wiring layer forming a top layer of the semiconductor substrate, and exposed to the outside from its surface-protection layer; and gold bumps formed on the electrode pads.

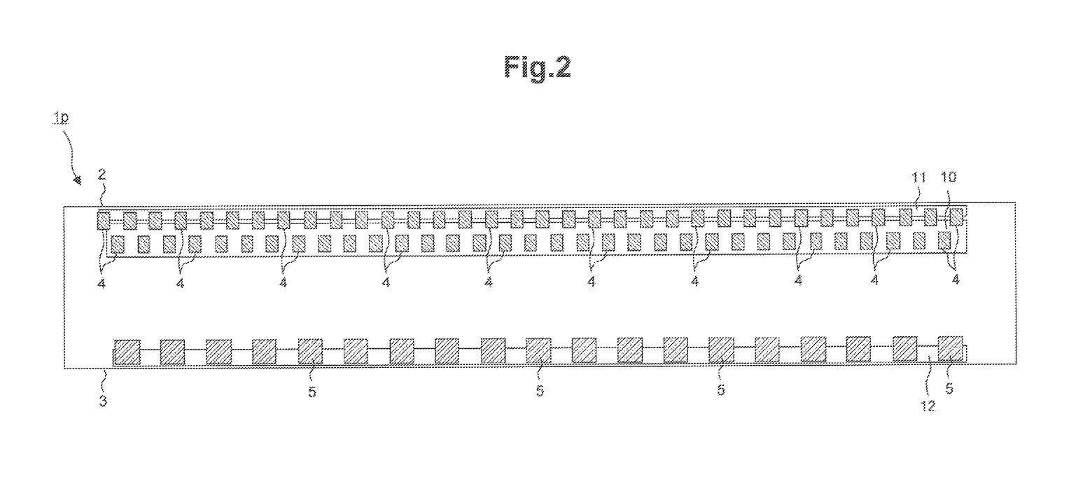

The driver IC shown in FIG. 1 has a free region 6 formed between the first edge side 2 and the row of the first external connection terminal 4 opposed to it so that a row of the external connection terminals 4 or more rows (e.g. 2 rows) thereof can be disposed there. In the drawing, the reference numeral 10 denotes a region (i.e. a region for drive buffer and other elements' formation) where a drive buffer and other elements connected with the first external connection terminals 4 are formed; the region is shown, by example, in plane view perspectively. The numeral 11 denotes a region (i.e. a region for protective element formation) where a protective element connected with the external connection terminals 4 is formed; the region is shown, by example, in plane view perspectively. In comparison to the region 10 for drive buffer and other elements' formation, and the region 11 for protective element formation, the rows of first external connection terminals 4 are located close to a center portion of the driver IC 1a in a short-side direction thereof. FIG. 2 shows, as a comparative example, a driver IC 1p without the free region 6 provided proactively. In the case of the driver IC 1p, the first external connection terminals 4 are disposed on the region 10 for drive buffer and other elements' formation and the region 11 for protective element formation. In short, unlike the driver IC 1p shown in FIG. 2, the driver IC 1a shown in FIG. 1 is arranged so that the rows of first external connection terminals 4 are displaced closer to the center portion along the short-side direction of the driver IC 1a to proactively provide the free region 6.

In the driver IC of FIG. 1, no free region is formed between the second edge side 3 and the row of second external connection terminals 5 opposed to it. In the drawing, the reference numeral 12 denotes a region where a host interface buffer connected with the second external connection terminals 5 is formed (i.e. a host-interface-buffer-formation region); the region is shown, by example, in plane view perspectively. Therefore, the driver IC shown in FIG. 1 is unchanged from that shown in FIG. 2 in the layout of the second external connection terminals 5.

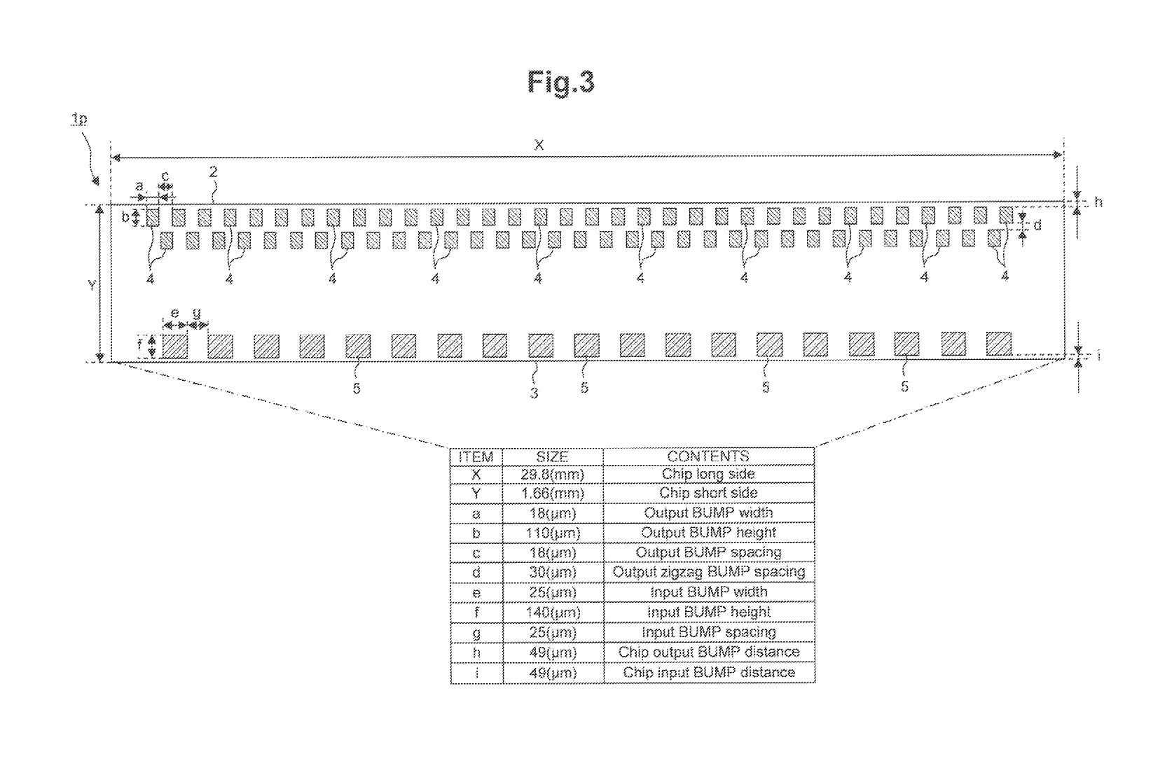

FIG. 3 shows, by example, a chip size and an electrode size of the driver IC 1p without the free region 6 as shown in FIG. 2. As shown in the drawing, the unit of the sizes x and y of the outside shape of the chip is millimeter (mm), and the unit of the others is micrometer (μm). Supposing that the first external connection terminal size b is 110 μm as in the example of FIG. 3, the size j (see FIG. 1) of the free region 6 of the chip 1a in the short-side direction is 220 which is twice the size b. The larger the size j is, the more distant from the buffers in the region 10 for drive buffer and other elements' formation the external connection terminals 4 are. Therefore, the size j may be determined so that it never makes difficult to wire lines between the external connection terminals 4 and the region 10. The maximum of the size j is within a range such that the influence of electric or electromagnetic noise on the second external connection terminals 5 can be ignored.

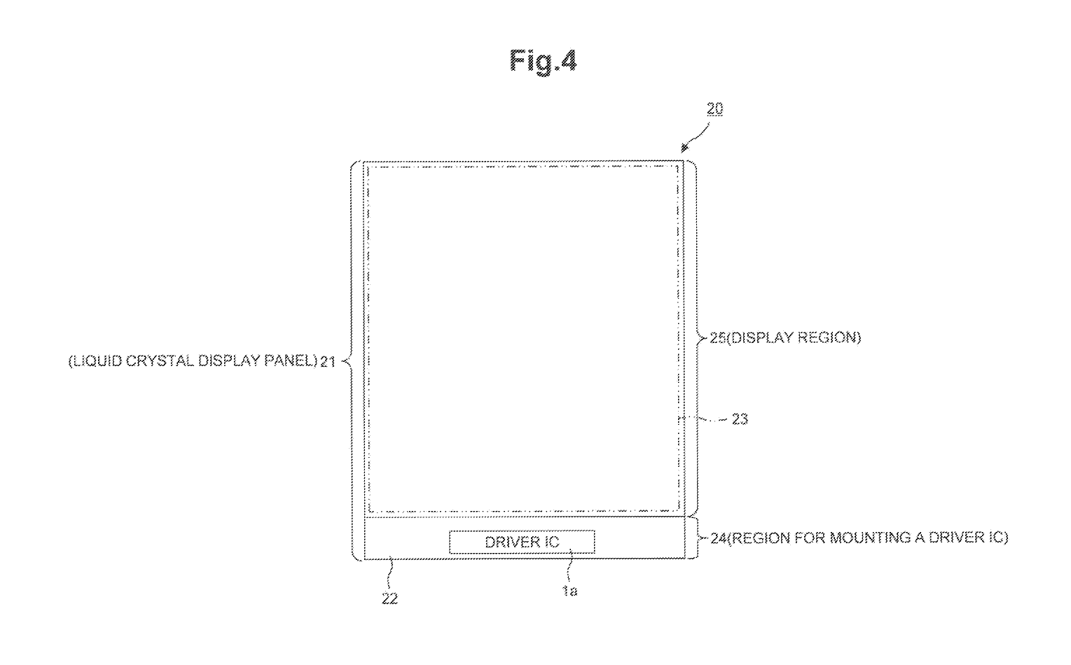

FIG. 4 shows, by example, the image display device 20 having a liquid crystal display panel 21 with the driver IC 1a mounted thereon. The liquid crystal display panel 21 includes a TFT array substrate 22 with TFTs and pixel electrodes arranged on a glass substrate like a matrix. The liquid crystal display panel further includes a liquid crystal layer, a common electrode layer opposed to the pixel electrodes, a color filter, a surface glass and the like, which are stacked on the TFT array substrate, as indicated by the reference numeral 23. In the drawing, an upper portion of the TFT array substrate 22 is used for a display region 25, and a lower portion thereof is used for a region 24 for mounting the driver IC 1a.

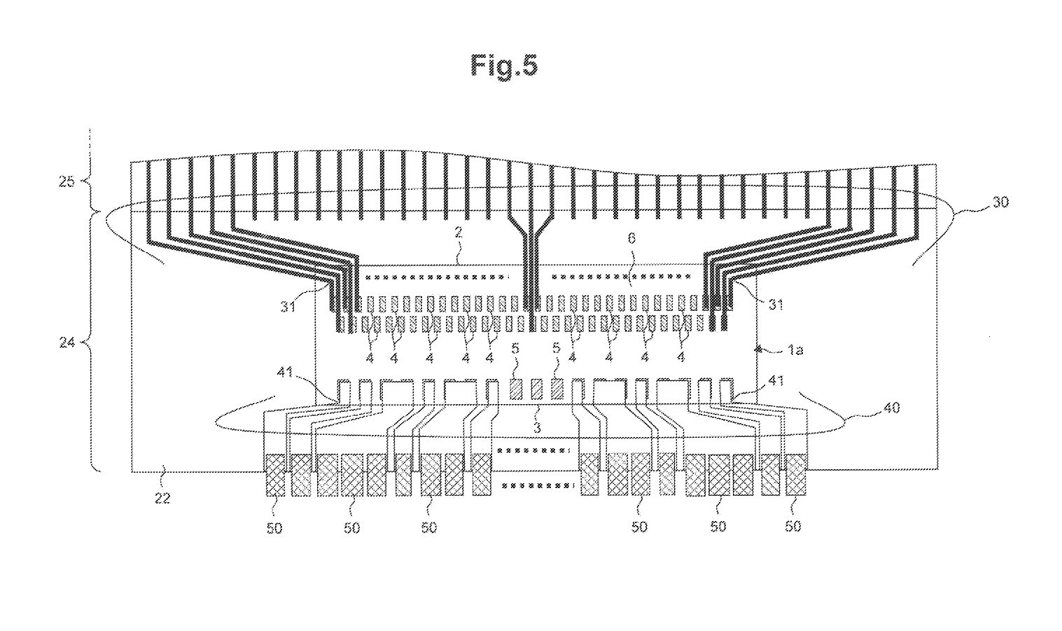

FIG. 5 shows, by example, the form for mounting the driver IC 1a on the TFT array substrate 22. The reference numeral 30 denotes a group of drive-side mount lines each led to where the driver IC 1a is COG-mounted in the driver IC-mount region 24 on the TFT array substrate 22. Likewise, the numeral 40 denotes a group of host-side mount lines. The group of drive-side mount lines 30 include e.g. gate and source lines of TFT. The number of the drive-side mount lines depends on the resolution of the liquid crystal display panel 21, etc. With the rise in the resolution, the number of the drive-side mount lines increases constantly. The long side of the driver IC 1a is remarkably smaller, in size, than the width of the TFT array substrate 22. Therefore, the drive-side mount lines 30 are bent at a midway along their lengths so as to be gathered toward a center portion of all the lines, whereby the pitch of the wiring lines is reduced. Though not to the extent of the scale-down of the pitch of the drive-side mount lines 30, the host-side mount lines 40 are likewise bent at a midway along their lengths so as to be gathered toward a center portion, whereby the pitch of the wiring lines is reduced. The host-side mount lines 40 are connected with FPC (Flexible printed circuit) wiring lines 50, which are partially shown in the drawing. The host-side mount lines are further interfaced through the FPC lines 50 to a host (or host device), which is not shown in the drawing.

The first external connection terminals 4 disposed in zigzag are connected with the corresponding drive-side mount lines 30. The second external connection terminals 5 are connected with the corresponding host-side mount lines 40. The driver IC 1a is mounted to connect the corresponding terminals 4, 5 from above the mount lines 30, 40. For instance, the driver IC 1a is fixed to the mount region 24 by a binder in AFC (Anisotropy Conductive Film) according to the steps of: putting AFC between the mount lines 30, 40, which are composed of transparent electrodes formed by ITO (Indium Tin Oxide) patterning, and gold bumps forming the terminals 4 and 5 of the driver IC 1a; and thereafter pressing the driver IC 1a against them from above, thereby crushing conductive beads in AFC and consequently, establishing required electrical continuity.

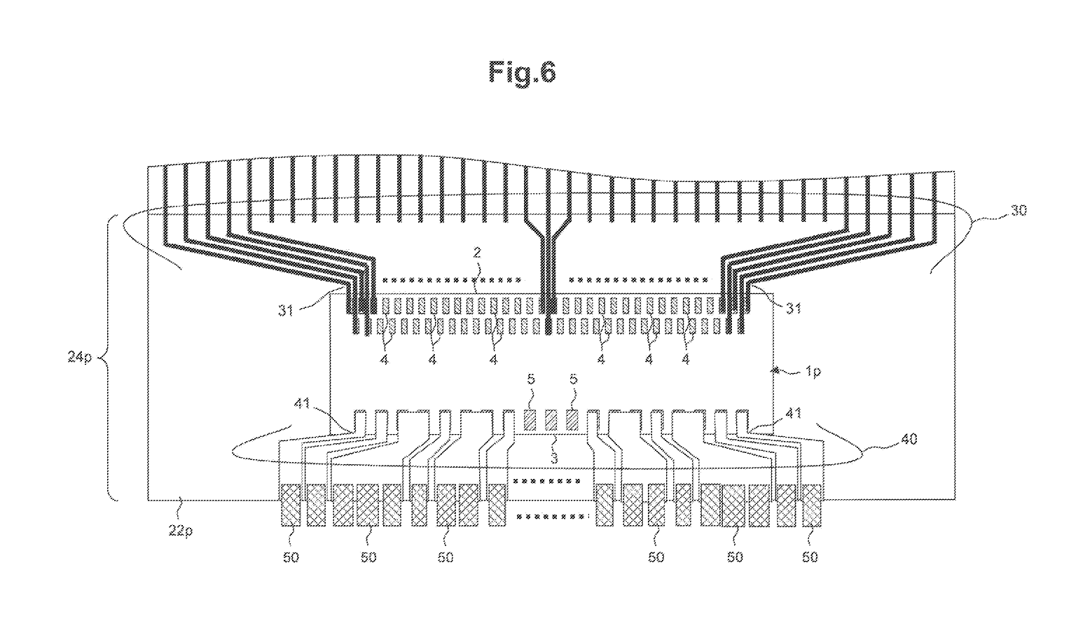

In this time, bent parts 31 of the drive-side mount lines 30 thus bent are arranged to partially overlie the free region 6 between the first edge side 2 and the row of the first external connection terminals 4. In case that the driver IC 1p without the free region 6 is mounted on the mount region 24p as shown in FIG. 6, the free region 6 is not provided in the driver IC 1p and therefore, none of the bent parts 31 overlie the driver IC 1p.

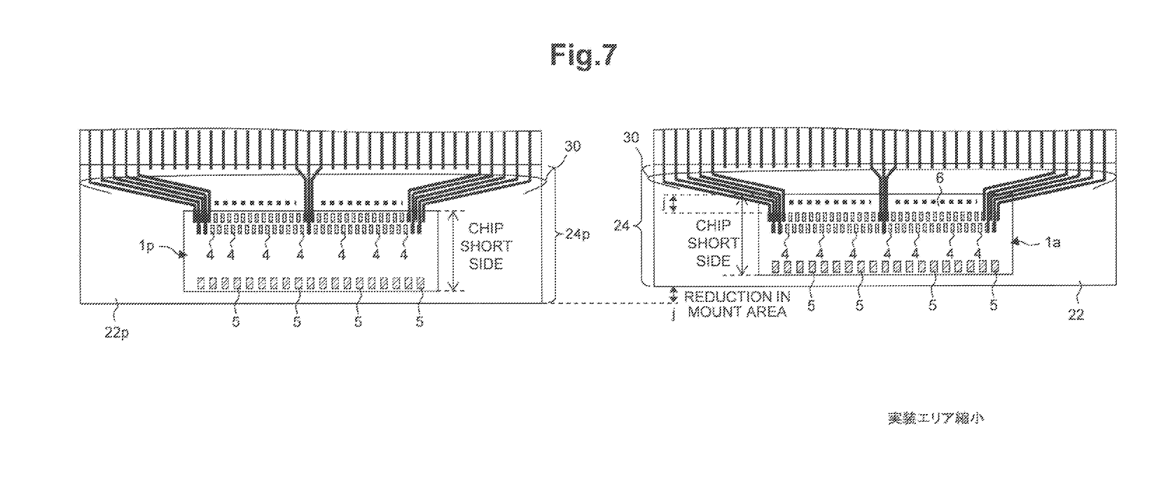

Referring to FIG. 7, the difference between the mounting form of FIG. 5 and that of FIG. 6 will be shown. As clear from the drawing, the short-side length of the mount region 24 is shorter than the short-side length of the mount region 24p by a length j of the short-side direction of the free region 6. This means that the same effect as achieved by reducing the size of the short-side of the driver IC 1a by the size j of the free region 6 is attained. Hence, without the need for reducing the chip size of the driver IC, the reduction in frame size of the image-display panel, therefore the TFT array substrate 22, namely the reduction of the driver IC-mount region to the display region of the TFT array substrate 22 is realized readily.

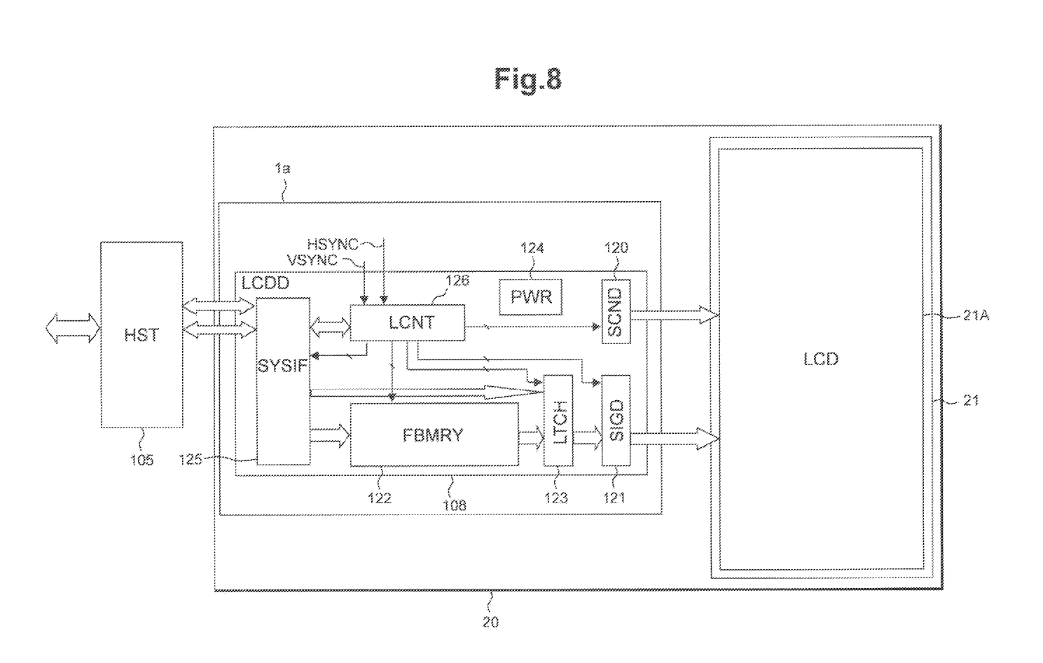

FIG. 8 is a block diagram showing, by example, the structure of the driver IC 1a. In FIG. 8, the driver IC 1a is shown as a part of a portable information terminal device such as a tablet or a smart phone. The reference numeral 105 denotes a host processor (HST) which is a host connected through the FPC 50. To the host processor 105, a communication-control unit, an image-processing unit, an audio-processing unit, an accelerator, etc., which are not shown in the drawing, are connected, whereby the portable information terminal device is formed.

In this embodiment, the liquid crystal display panel 21 consists predominantly of a liquid crystal display device (LCD) 21A. While not particularly shown in the drawing, the liquid crystal display device 21A has e.g. display-scan electrodes and display signal electrodes arranged to intersect with one another, and thin-film transistors, referred to as “TFTs” at intersection points of the display-scan electrodes and display signal electrodes, respectively. Each pixel is formed by connecting a gate of the thin-film transistor to one display-scan electrode (gate electrode line), a source to one display signal electrode (source electrode line), and a drain to a liquid crystal element and a storage capacitor making a sub-pixel between the drain and the common electrode. In the display control, the display-scan electrodes are sequentially driven to turn ON the thin-film transistors by display-scan electrode. As a result, electric current is caused to flow between the source and drain of each of the thin-film transistors in ON state, when a signal voltage which is being supplied to the source through the display signal electrode is applied to the corresponding liquid crystal element. In this way, the gradation is controlled.

Although no special restriction is intended, the driver IC 1a has a display controller (LCDD) 108. The display controller 108 has e.g. a scan-drive circuit (SCND) 120, a gradation-drive circuit (SIGD) 121, a frame buffer memory (FBMRY) 122, a line-latch circuit (LTCH) 123, a power supply circuit 124, a system interface circuit (SYSIF) 125, and a display-control circuit (LCNT) 126 operable to totally control the display controller 108. The display controller 108 performs the display control of the liquid crystal display panel 21 in synchronization with a frame synchronizing signal. In FIG. 8, the frame synchronizing signal is e.g. a vertical synchronizing signal VSYNC. Although no special restriction is intended, the vertical synchronizing signal VSYNC and the horizontal synchronizing signal HSYNC are supplied to the display-control circuit 126 from outside the driver IC 1a.

The system interface 125 receives a display command and display data from the host processor 105. The received display data are directly transmitted to the line-latch circuit 123 with the timing in line with the display timing according to the display form thereof, otherwise such data are drawn on the frame buffer memory 122 for each display frame and then transmitted, by display line, to the line-latch circuit 123.

The transmission of display data to the line-latch circuit 123 is performed for each horizontal scan period synchronized with the horizontal synchronizing signal HSYNC. The gradation-drive circuit 121 outputs gradation voltages in parallel to the display signal electrodes of the liquid crystal display panel 21 according to display data latched by the line-latch circuit 123. The scan-drive circuit 120 sequentially drives the display-scan electrodes of the liquid crystal display panel 21 in synchronization with the horizontal synchronizing signal HSYNC in each frame cycle. Thus, the thin-film transistors are turned ON for each display-scan electrode, and then electric current is caused to flow between a source and a drain each of the thin-film transistors in ON state. At that time, the gradation-drive circuit 121 applies, based on display data latched by the line-latch circuit 123 for each horizontal scan period, a signal voltage as a gradation voltage to the appropriate source through the display signal electrode, and then to the liquid crystal element. As a result, in synchronization with the sequential scan driving of the display-scan electrodes for each frame cycle, the liquid crystal elements are driven in units of display lines according to the gradation data. The power supply circuit 124 produces a gradation voltage output by the gradation-drive circuit 121, a scan drive voltage output by the scan-drive circuit 120, etc. The display-control circuit 126 performs the general control of the display controller 108, including the display control thereof, according to a display command provided from the host processor 105.

In the case of adopting the driver IC 1a as described with reference to FIG. 8, drive buffers to be included in the gradation-drive circuit 121 and the scan-drive circuit 120 are disposed in the region 10 for drive buffer and other elements' formation as described with reference to FIG. 1, which are coupled to the first external connection terminals 4. In the host-interface-buffer-formation region 12 as described with reference to FIG. 1, input and output buffers are disposed, which serve as system interface buffers included in the system interface circuit 125, and are coupled to the second external connection terminals 5.

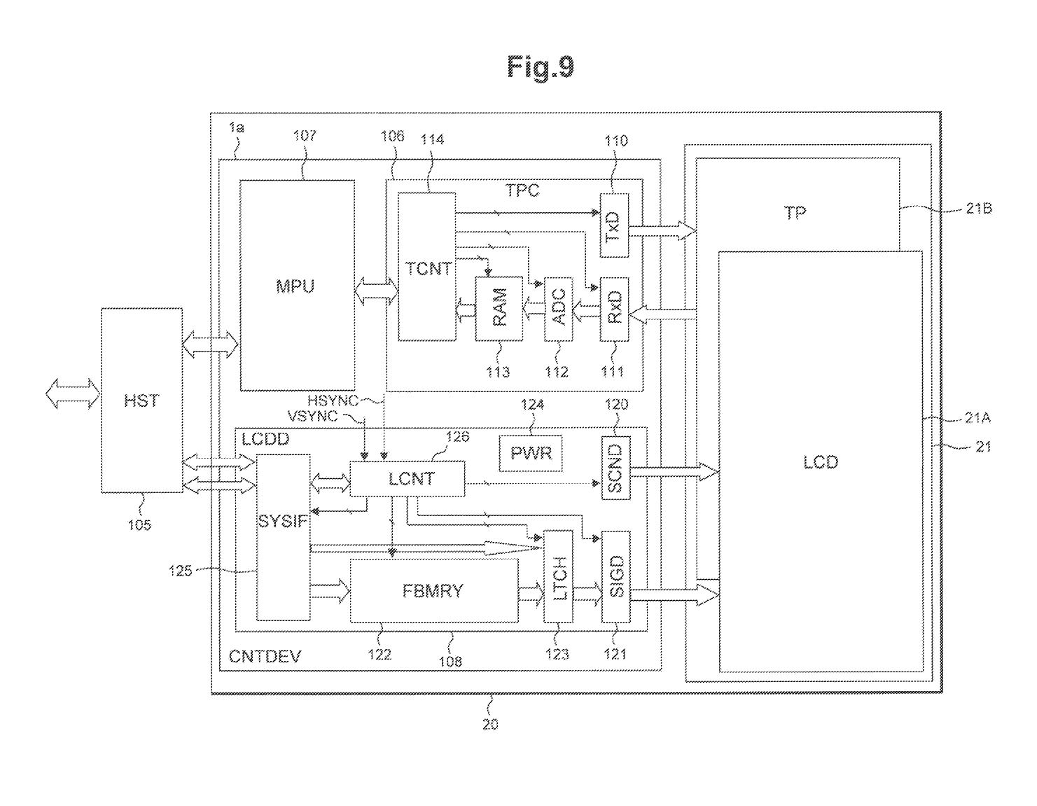

FIG. 9 is a block diagram showing, by example, another structure of the driver IC 1a. The driver IC shown in FIG. 9 is different from the driver IC shown in FIG. 8 in that the image-display panel 21 has a touch panel 21B incorporated therein, and the driver IC 1a has a touch panel controller (TPC) 106 and a subprocessor (MPU) 107 additionally. In FIG. 9, parts or members identical in function to those of the driver IC 1a as shown in FIG. 8 are identified by the same reference numerals, and the detailed descriptions thereof are omitted here.

The image-display panel 21 has a TFT array substrate 22, a liquid crystal display device 21A formed over the TFT array substrate 22, and a touch panel (TP) 21B incorporated over the TFT array substrate 22. The touch panel 21B is arranged in a so-called in-cell form, which is incorporated in the liquid crystal display device 21A.

The liquid crystal display device 21A is arranged in the same way as that shown in FIG. 8 is.

The touch panel 21B is arranged a touch and no touch can be detected according to a mutual capacitance technique to support a multipoint touch. For instance, the touch panel 21B has a number of detection capacitances formed at intersections of detection-scan electrodes and detection signal electrodes arranged to intersect with one another like a matrix. The touch panel 21B is operable to form detection signals by: sequentially driving the detection-scan electrodes, and then integrating potential changes arising on the detection signal electrodes through the detection capacitances. In case that a finger is brought close to the detection capacitances, the stray capacitance of the finger is combined with the detection capacitances, and thus the combined capacitance values become smaller. The mutual capacitance type touch panel is arranged to be able to discriminate between the states of “being touched” and “being untouched” based on the differences of the detection signals according to the changes of the capacitance values.

The touch panel controller 106 has e.g. a drive circuit (T×D) 110, a detection circuit (R×D) 111, an analog-to-digital conversion circuit (ADC) 112, RAM 113, and a touch control circuit (TCNT) 114. The drive circuit 110 outputs a drive pulse to the detection-scan electrodes of the touch panel 21B sequentially. Voltage changes developed on the detection signal electrodes through the detection capacitances connected with the driven detection-scan electrodes are accumulated by an integration circuit of the detection circuit 111, and then detection signals are formed for each detection signal electrode. The detection signals are converted from analog signals to digital signals in ADC 112. The resultant digital signals are accumulated by RAM 113 as detection data. The touch control circuit 114 controls the order in which the drive circuit 110 drives the detection-scan electrodes, and the drive timing thereof, and controls, in synchronization with the drive timing, the action timings of the detection circuit 111 and ADC 112 and the writing action on RAM 113. The detection data obtained by the scan driving of the detection-scan electrodes for the whole screen of touch panel 21B, and the detecting action on the whole screen, i.e. the scan driving and the detecting action on the touch panel 21B for each frame are accumulated by RAM 113. Then, the touch control circuit 114 provides the detection data to the subprocessor 107. The subprocessor 107 determines whether the touch panel is being touched or not based on the detection data, calculates the position coordinate of a touch position in the touch panel 21B, and provides a result of the calculation to the host processor 105.

In the case of adopting the driver IC 1a as described with reference to FIG. 9, in addition to the drive buffers included in the gradation-drive circuit 121 and the scan-drive circuit 120 of the display controller 108, a drive buffer included in the drive circuit (T×D) 110 of the touch panel controller 106 and an input buffer included in the detection circuit (R×D) 111 of the touch panel controller 106 are disposed in the region 10 for drive buffer and other elements' formation as described with reference to FIG. 1; they are coupled to the corresponding first external connection terminals 4. In the host-interface-buffer-formation region 12 as described with reference to FIG. 1, in addition to input and output buffers as system interface buffers included in the system interface circuit 125 of the display controller 108, a host interface buffer included in the subprocessor 107 is disposed, and they are coupled to the corresponding second external connection terminals 5.

According to the first embodiment, the following effect and advantage can be achieved.

(1) Adopted is the driver IC 1a having the free region 6 formed on the side of the first external connection terminals 4. The driver IC 1a is mounted on the TFT array substrate 22; on the driver IC 1a, the bent parts 31 of lead-out lines 30 led out from the display panel and bent at a midway along their lengths to have a narrowed pitch are put in position to overlie the free region 6. Thus, the same effect as achieved by reducing the short side of the driver IC 1a by the size j of the free region 6 can be obtained. Hence, the reduction in frame size of an image-display panel can be realized readily without the need for reducing the chip size of a driver IC 1a.

(2) Since the free region 6 is also formed on the side of the scan driving and touch detection buffers of the touch panel controller 106, the reduction in frame size of a display panel can be realized readily even in case that the number of the first external connection terminals 4 for touch drive and touch detection is increased by the driver IC 1a including a touch panel controller 106 and consequently the reduction in the pitch of drive-side external connection terminals 4 is caused to further progress.

(3) The same effect and advantage as those described above can be obtained even in case that the drive-side external connection terminals 4 of a driver IC 1a having its limits in chip size cannot be arranged in line owing to the increase in the number of the external connection terminals, and there is no other choice but to dispose the external connection terminals 4 in zigzag.

### Second Embodiment

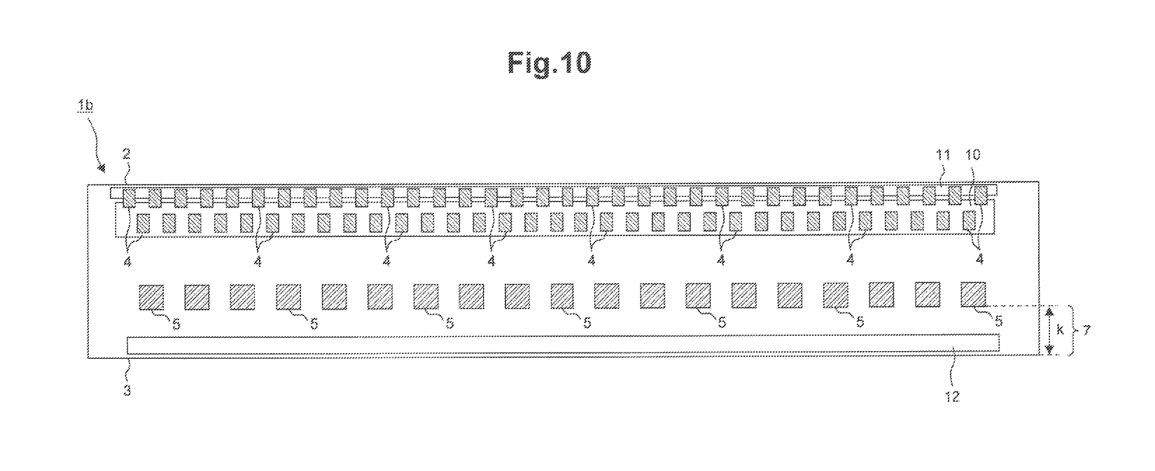

FIG. 10 shows, by example, the second embodiment of the external connection terminal array of the driver IC to be mounted on a display panel. The driver IC 1b shown in the drawing is a semiconductor chip used to activate a circuit to be activated, such as a display panel, which is also referred to as “bare chip” or “flip chip”. Although no special restriction is intended, the driver IC 1b is arranged by forming a required circuit on a substrate such as a substrate of semiconductor typified by a monocrystalline silicon by the semiconductor integrated circuit manufacturing techniques including CMOS integrated circuit manufacturing technique.

The driver IC 1b has, in plane view, an appearance of a rectangular form having a pair of first and second edge sides 2 and 3 in parallel with each other. The driver IC 1b includes rows of external connection terminals 4 and 5 formed near the first and second edge sides; the rows of first external connection terminals 4 are near the first edge side 2, and the row of second external connection terminal 5 is near the second edge side. Although no special restriction is intended, the external connection terminals 4 are disposed in zigzag, forming two rows.

The driver IC shown in FIG. 10 has a free region 7 formed between the second edge side 3 and the row of the second external connection terminals 5 opposed to it so that at least one row of the external connection terminals 5 can be disposed there. In the drawing, the reference numeral 12 denotes a region (i.e. a host-interface-buffer-formation region) where host interface buffers connected with the second external connection terminals 5 are formed; the region is shown, by example, in plane view perspectively. In comparison to the host-interface-buffer-formation region 12, the row of the second external connection terminals 5 is located close to a center portion of the driver IC1 in a short-side direction thereof. FIG. 2 shows, as a comparative example, a driver IC 1p without the free region 6 provided proactively. In the case of the driver IC 1p, the row of the second external connection terminals 5 is disposed on the host-interface-buffer-formation region 12. In short, unlike the driver IC 1p shown in FIG. 2, the driver IC 1b shown in FIG. 10 is arranged so that the row of second external connection terminals 5 is displaced closer to the center portion along the short-side direction of the driver IC 1b to proactively provide the free region 7.
In the driver IC of FIG. 10, no free region is formed between the first edge side 2 and the row of first external connection terminals 4 opposed to it. Therefore, the driver IC shown in FIG. 10 is unchanged from that shown in FIG. 2 in the layout of the first external connection terminals 4.

Supposing that the size f of the second external connection terminals 5 is 140 μm as in the example of FIG. 3, the size k (see FIG. 10) of the free region 7 of the chip 1b in the short-side direction is 280 μM, which is twice the size f. The larger the size k is, the more distant from the buffers in the host-interface-buffer-formation region 12 the external connection terminals 5 are. The size k may be determined within the bounds of not making difficult the wiring between the external connection terminals 5 and the buffers in the host-interface-buffer-formation region 12. The maximum of the size k is within a range such that the influence of electric or electromagnetic noise on the first external connection terminals 4 can be ignored.

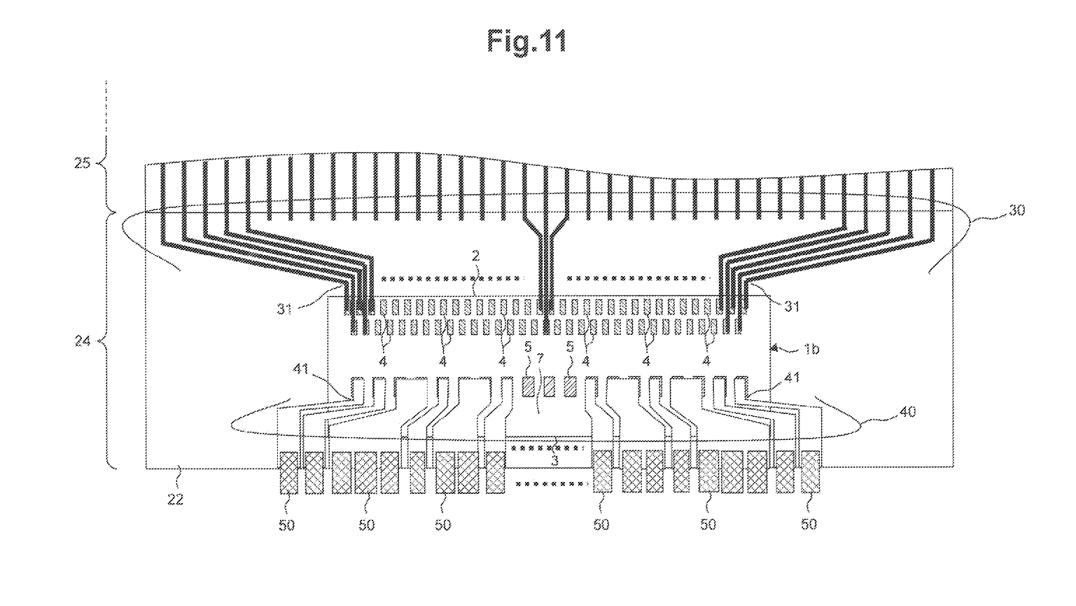

FIG. 11 shows, by example, the form of mounting the driver IC 1b on the TFT array substrate 22. The reference numeral 30 denotes a group of drive-side mount lines each led to where the driver IC 1b is COG-mounted in the driver IC-mount region 24 on the TFT array substrate 22. Likewise, the numeral 40 denotes a group of host-side mount lines. The group of drive-side mount lines 30 includes e.g. gate and source lines of TFT. The number of the drive-side mount lines depends on the resolution of the liquid crystal display panel 21, etc. With the rise in the resolution, the number of the drive-side mount lines increases constantly. The long side of the driver IC 1b is remarkably smaller, in size, than the width of the TFT array substrate 22. Therefore, the drive-side mount lines 30 are bent at a midway along their lengths so as to be gathered toward a center portion of all the lines, whereby the pitch of the wiring lines is reduced. Though not to the extent of the scale-down of the pitch of the drive-side mount lines 30, the host-side mount lines 40 are likewise bent at a midway along their lengths so as to be gathered toward a center portion, whereby the pitch of the wiring lines is reduced. The host-side mount lines 40 are connected with FPC (Flexible printed circuit) wiring lines 50, which are partially shown in the drawing. The host-side mount lines are further interfaced through the FPC lines 50 to a host (or host device), which is not shown in the drawing.

The first external connection terminals 4 disposed in zigzag are connected with the corresponding drive-side mount lines 30. The second external connection terminals 5 are connected with the corresponding host-side mount lines 40. The driver IC 1b is mounted to connect the corresponding terminals 4, 5 from above the mount lines 30, 40. For instance, the driver IC 1b is fixed to the mount region 24 by a binder in AFC (Anisotropy Conductive Film) according to the steps of: putting AFC between the mount lines 30, 40, which are composed of transparent electrodes formed by ITO (Indium Tin Oxide) patterning, and gold bumps forming the terminals 4 and 5 of the driver IC 1b; and thereafter pressing the driver IC 1b against them from above, thereby crushing conductive beads in AFC and consequently, establishing required electrical continuity.

In this time, bent parts 41 of the drive-side mount lines 40 thus bent are arranged to partially overlie the free region 7 between the second edge side 3 and the row of the second external connection terminals 5. In case that the driver IC 1p without the free region 7 is mounted on the mount region 24p as shown in FIG. 6, the free region 7 is not provided in the driver IC 1p and therefore, none of the bent parts 41 overlie the driver IC 1p.

As clear from the comparison between the mounting forms described with reference to FIG. 11 and FIG. 6, the short-side length of the mount region 24 is shorter than the short-side length of the mount region 24p by a length k of the short-side direction of the free region 7. This means that the same effect as achieved by reducing the size of the short-side of the driver IC 1b by the size k of the free region 7 is attained. Hence, without the need for reducing the chip size of the driver IC, the reduction in frame size of the image-display panel, therefore a portion surrounding the TFT array substrate 22, namely the reduction of the size of a non-display region to the size of the TFT array substrate 22 is realized readily.

Also, it is possible to adopt, for the driver IC 1b, the form having a display controller (LCDD) 108 as described with reference to FIG. 8, the form having a touch panel controller (TPC) 106 and a subprocessor (MPU) 107 in addition to a display controller (LCDD) 108 as described with reference to FIG. 9, and the like, which each fulfill a function in terms of the circuit structure thereof.

Now, it is noted that the same parts or members as those in the first embodiment will be identified by the same reference numerals, and the detailed description thereof are omitted.

The effect and advantage that the second embodiment brings about are as follows.

(1) Adopted is the driver IC 1b having the free region 7 formed on the side of the second external connection terminals 5. The driver IC 1b is mounted on the TFT array substrate 22; on the driver IC 1b, the bent parts 41 of lead-out lines 40 led out from the display panel and bent at a midway along their lengths to have a narrowed pitch are put in position to overlie the free region 7. Thus, the same effect as achieved by reducing the short side of the driver IC 1b by the size k of the free region 7 can be obtained. Hence, the reduction in frame size of an image-display panel can be realized readily without the need for reducing the chip size of a driver IC 1b.

(2) Since the free region 7 is also formed on the host interface buffer side of the subprocessor 107, the reduction in frame size of a display panel can be realized readily even in case that the number of the second external connection terminals 5 for touch drive and touch detection is increased by the driver IC 1b including a touch panel controller 106 and consequently the reduction in the pitch of the external connection terminals 5 on the interface buffer side is caused to further progress.

### Third Embodiment

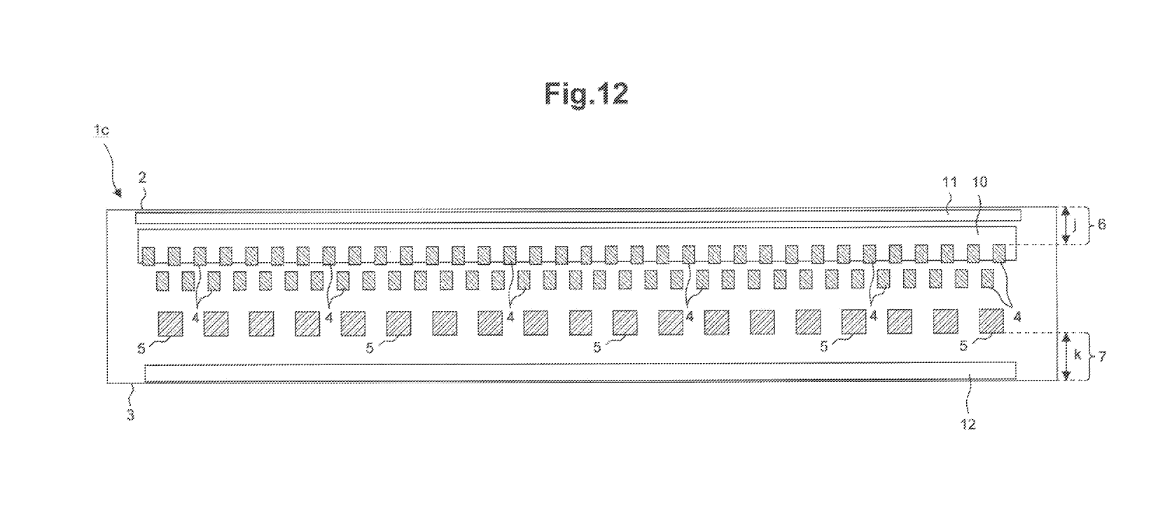

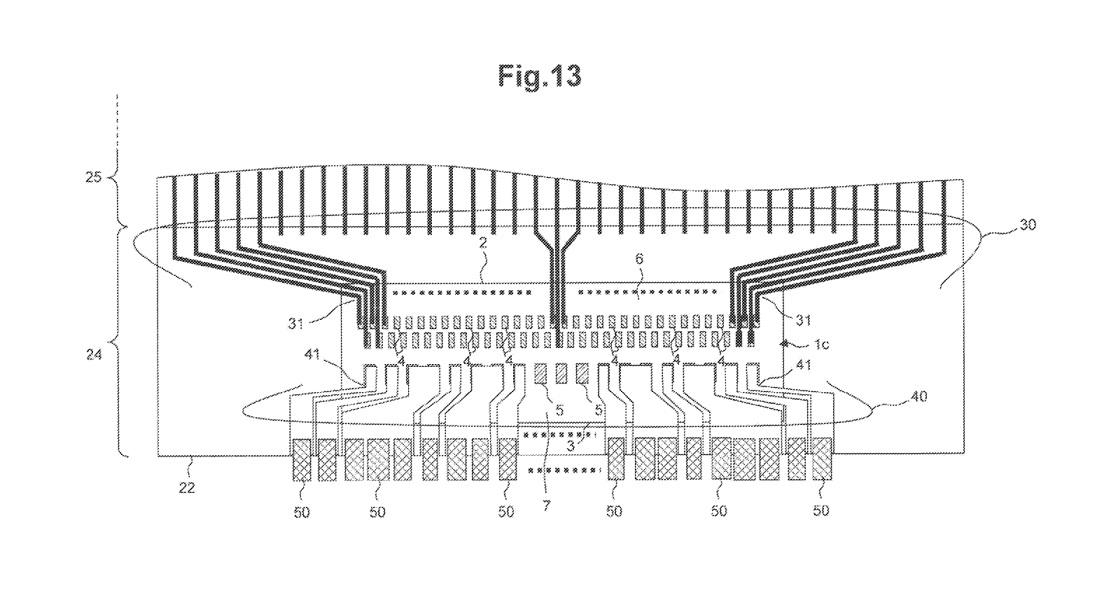

FIG. 12 shows, by example, the third embodiment of the external connection terminal array of the driver IC to be mounted on a display panel. FIG. 13 shows, by example, the form of mounting the driver IC 1c on the TFT array substrate 22. The driver IC 1c shown in the drawing is a semiconductor chip used to activate a circuit to be activated, such as a display panel, which is also referred to as “bare chip” or “flip chip”. Although no special restriction is intended, the driver IC 1c is arranged by forming a required circuit on a substrate such as a substrate of semiconductor typified by a monocrystalline silicon by the semiconductor integrated circuit manufacturing techniques including CMOS integrated circuit manufacturing technique.

The driver IC 1c has, in plane view, an appearance of a rectangular form having a pair of first and second edge sides 2 and 3 in parallel with each other. The driver IC 1c includes rows of external connection terminals 4 and 5 formed near the first and second edge sides; the rows of first external connection terminals 4 are near the first edge side 2, and the row of second external connection terminal 5 is near the second edge side. Although no special restriction is intended, the external connection terminals 4 are disposed in zigzag, forming two rows.

The driver IC shown in FIGS. 12 and 13 has a free region 6 formed between the first edge side 2 and the row of the first external connection terminals 4 opposed to it so that at least one row of the external connection terminals 4 can be disposed there as in the first embodiment. Further, a free region 7 is formed between the second edge side 3 and the row of the second external connection terminals 5 opposed to it so that at least one row of the external connection terminals 5 can be disposed there as in the second embodiment. The driver IC 1c according to the third embodiment has both of a feature in connection with the free region 6 of the driver IC 1a of FIG. 1 and a feature in connection with the free region 7 of the driver IC 1b of FIG. 10.

Now, it is noted that the sizes j and k of the free regions 6 and 7 may be determined within a range such that the influence of mutual electric or electromagnetic noise on both the first and second external connection terminals 4 and 5 can be ignored. The same effect as achieved by reducing the size of the short side of the driver IC 1c by a quantity representing the sum of the sizes j and k of the free regions 6 and 7 can be obtained. Therefore, as shown in FIG. 13, by example, the size of the short side of the mount region 24 is shorter than those of the mount regions of the driver ICs as shown in FIGS. 5 and 11.

The other constituents are the same as those in the first and second embodiments and therefore, parts or members having the same functions are identified by the same reference numerals, and the detailed descriptions thereof are omitted here.

The third embodiment brings about the following effect and advantage.

(1) Adopted is the driver IC 1c having the free region 6 formed on the side of the first external connection terminals 4, and the free region 7 formed on the side of the second external connection terminals 5. The driver IC 1c is mounted on the TFT array substrate 22; on the driver IC 1c, the bent parts 31 and 41 of lead-out lines 30 and 40 led out from the display panel and bent at a midway along their lengths to have a narrowed pitch are put in position to overlie the free regions 6 and 7. The same effect as achieved by reducing the size of the short side of the driver IC 1c by a quantity representing the sum of the sizes j and k of the free regions 6 and 7 can be obtained. Therefore, the reduction in frame size of the image-display panel can be realized readily without the need for reducing the chip size of the driver IC 1c.

(2) Since the free region 7 is also formed on the host interface buffer side of the subprocessor 107, the reduction in frame size of a display panel can be realized readily even in case that the number of the second external connection terminals 5 for touch drive and touch detection is increased by the driver IC 1c including a touch panel controller 106 and consequently the reduction in the pitch of the external connection terminals 5 on the interface buffer side is caused to further progress.

The invention is not limited to the above embodiments. It is obvious that various changes and modifications may be made without departing from the subject matter thereof.

For instance, the driver IC may be arranged to drive only the gate electrodes of TFTs or only the signal electrodes, otherwise separate ICs having the functions respectively may be used instead. It is obvious that the driver IC-mount region is not limited so as to be laid out close to only one side of the display region, and it may be laid out to upper and lower sides, or to the whole peripheral portion. In addition, the driver IC having no subprocessor may be arranged so that the host processor serves to carry out the function of calculating a coordinate in response to a touch detection. Further, to cope with a large-size display panel, a plurality of driver ICs may be arranged in parallel. The external connection terminals are not limited so that they are arranged in zigzag and form two rows. The external connection terminals may be arranged to form one row, or arranged in zigzag to form three or more rows. The display panel is not limited to a liquid crystal display panel, and it may be an electroluminescence panel or the like. The invention can be widely applied to not only portable information terminals including a tablet and a smart phone, but also image display devices including a personal computer, a workstation, a television receiver, etc., and driver ICs used in these devices.

What is claimed is:

1. An image display device comprising:
an image-display panel having a TFT array substrate with TFTs and pixel electrodes arranged like a matrix; and
a driver IC mounted on the TFT array substrate of the image-display panel according to COG technique,
wherein drive-side mount lines and host-side mount lines are each led to where the driver IC is COG-mounted on the TFT array substrate and bent at a midway along their lengths, whereby their line pitches are reduced,
the driver IC has, in plane view, an appearance of a rectangular form, and has a row of first external connection terminals close to a first edge side corresponding to one of a pair of long sides of the rectangular form extending along a longitudinal direction thereof, and which are connected with the drive-side mount lines, and a row of second external connection terminals close to a second edge side corresponding to the other long side of the rectangular form, and connected with the host-side mount lines, and
bent parts where the drive-side mount lines are bent are formed in position so as to partially overlie a free region between the first edge side and the row of first external connection terminals.

2. The image display device according to claim 1, wherein the driver IC has a display controller operable to drive TFT electrodes through the first external connection terminals, and
the drive-side mount lines include wiring lines connecting to the electrodes.

3. The image display device according to claim 2, wherein the image-display panel has a touch panel incorporated in an upper portion of the TFT array substrate,
the driver IC further has a touch panel controller operable to control, through the first external connection terminals, activation of the touch panel and touch detection, and
the drive-side mount lines include wiring lines which connect to drive electrodes and detection electrodes of the touch panel.

4. The image display device according to claim 1, wherein bent parts where the host-side mount lines are bent are formed in position so as to partially overlie a free region between the second edge side and the row of second external connection terminals.

5. The image display device according to claim 4, wherein the driver IC has a display controller operable to drive TFT electrodes through the first external connection terminals, and connected to the host-side mount lines through the second external connection terminals,
the drive-side mount lines include wiring lines connecting to the electrodes, and
the host-side mount lines include wiring lines connectable to FPC (flexible Printed Circuit) for interfacing the image-display panel to outside.

6. The image display device according to claim 5, wherein the image-display panel has a touch panel incorporated in an upper portion of the TFT array substrate,
the driver IC further has a touch panel controller operable to control, through the first external connection terminals, activation of the touch panel and touch detection, and a data processor connected with the touch panel controller and connected through the second external connection terminals to the host-side mount lines, and
the drive-side mount lines include wiring lines connecting to drive electrodes and detection electrodes of the touch panel.

7. An image display device comprising:
an image-display panel having a TFT array substrate with TFTs and pixel electrodes arranged like a matrix; and
a driver IC mounted on the TFT array substrate of the image-display panel according to COG technique,
wherein drive-side mount lines and host-side mount lines are each led to where the driver IC is COG-mounted on the TFT array substrate and bent at a midway along their lengths, whereby their line pitches are reduced,
the driver IC has, in plane view, an appearance of a rectangular form, and has a row of first external connection terminals close to a first edge side corresponding to one of a pair of long sides of the rectangular form extending along a longitudinal direction thereof, and which are connected with the drive-side mount lines, and a row of second external connection terminals close to a second edge side corresponding to the other long side of the rectangular form, and connected with the host-side mount lines, and
bent parts where the host-side mount lines are bent are formed in position so as to partially overlie a free region between the second edge side and the row of second external connection terminals.

8. The image display device according to claim 7, wherein the driver IC has a display controller operable to drive TFT electrodes through the first external connection terminals, and connected to the host-side mount lines through the second external connection terminals,
the drive-side mount lines include wiring lines connecting to the electrodes, and
the host-side mount lines include wiring lines connectable to FPC (flexible Printed Circuit) for interfacing the image-display panel to outside.

9. The image display device according to claim 8, wherein the image-display panel has a touch panel superposed on the TFT array substrate,
the driver IC further has a touch panel controller operable to control, through the first external connection terminals, activation of the touch panel and touch detection, and a data processor connected with the touch panel controller and connected through the second external connection terminals to the host-side mount lines, and
the drive-side mount lines include wiring lines connecting to drive electrodes and detection electrodes of the touch panel.

10. A driver IC used to activate a display panel, having, in plane view, an appearance of a rectangular form having a pair of first and second edge sides in parallel with each other, and having rows of external connection terminals formed close to the first and second edge sides respectively, comprising:
a free region formed between at least one of the first and second edge sides and the row of external connection terminals opposed thereto, and arranged so that at least one row of external connection terminals can be disposed therein.

11. The driver IC according to claim 10, comprising: a display controller used to activate a display panel as an internal circuit connected to the row of external connection terminals,
wherein the display controller has display drive buffers connected to the external connection terminals close to the first edge side, and
the free region is formed between the first edge side and the external connection terminals opposed thereto.

12. The driver IC according to claim 11, wherein the display controller has a host interface buffer connected to the external connection terminals close to the second edge side, and
the free region is also formed between the second edge side and the external connection terminals opposed thereto.

13. The driver IC according to claim 11, further comprising:
a touch panel controller used for activation of a touch panel and touch detection as an internal circuit connected to the row of external connection terminals,
wherein the touch controller has a touch drive buffer and a touch detection input buffer connected to the external connection terminals close to the first edge side.

14. The driver IC according to claim 13, further comprising, as the internal circuit, a data processor connected with the touch panel controller,
wherein the display controller has a host interface buffer,
the data processor has a host interface buffer,
the host interface buffers are connected to the external connection terminals close to the second edge side, and
the free region is also formed between the second edge side and the external connection terminals opposed thereto.

15. The driver IC according to claim 10, further comprising a display controller used to activate a display panel as an internal circuit connected to the row of external connection terminals,
wherein the display controller has display drive buffers connected to the external connection terminals close to the first edge side,
the display controller has a host interface buffer connected to the external connection terminals close to the second edge side, and
the free region is formed between the second edge side and the external connection terminals opposed thereto.

16. The driver IC according to claim 15, further comprising, as an internal circuit connected to the row of external connection terminals:
a touch panel controller used for activation of a touch panel and touch detection; and a data processor connected with the touch panel controller,
wherein the touch panel controller has a touch drive buffer and a touch detection input buffer, both connected to the external connection terminals close to the first edge side,
the data processor has a host interface buffer connected to the external connection terminals close to the second edge side.

17. The driver IC according to claim 10, wherein the external connection terminals close to the first edge side are arranged in zigzag and form a plurality of rows.
